(19) United States
(12) Patent Application Publication
(10) Pub. No.: US 2006/0224880 A1
(43) Pub. Date: Oct. 5, 2006

(54) Information processing apparatus and boot processing control method for information processing apparatus

(76) Inventors: Terunobu Hara, Ome-shi (JP); Shuji Hori, Iruma-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/365,206

(22) Filed: Mar. 1, 2006

(30) Foreign Application Priority Data
Mar. 31, 2005 (JP) 2005-105176

(51) Int. Cl. G06F 15/177

(52) U.S. Cl. 713/2

(57) ABSTRACT

In a boot processing control method for an information processing apparatus according to this invention, the first boot device in which a medium can be loaded or a boot device different from the first boot device is designated. When a boot process cannot be executed from the first boot device in accordance with designation of the first boot device, a user is prompted to load the medium in the first boot device. After the user is prompted to load the medium in the first boot device, when the boot process of the operating system cannot be executed from the first boot device in which the user loads the medium, the boot process of the operating system is executed from the boot device different from the first boot device.

### CROSS-REFERENCE TO RELATED APPLICATIONS

This application is based upon and claims the benefit of priority from Japanese Patent Application No. 2005-105176, filed Mar. 31, 2005, the entire contents of which are incorporated herein by reference.

### BACKGROUND

1. Field

One embodiment of the invention relates to an information processing apparatus such as a computer, and a boot processing control method for the information processing apparatus.

2. Description of the Related Art

Generally, a computer has a plurality of boot devices. The computer boots an operating system from a boot device having highest priority among the plurality of boot devices such as an optical disc drive and hard disc drive.

It is disclosed by, for example, Jpn. Pat. Appln. KOKAI Publication No. 10-307725 (pp. 4-5, FIG. 2) conventionally, in the process of booting the operating system from a CD-ROM drive, the following technique has been proposed. A process of automatically opening the tray of the CD-ROM drive upon power-on of the computer apparatus, and a process of displaying and outputting a guide message on a display device to cause a user to load a boot CD-ROM into the tray of the CD-ROM drive are repeatedly performed until the boot CD-ROM is loaded into the tray of the CD-ROM drive.

However, in the technique disclosed in Jpn. Pat. Appln. KOKAI Publication No. 10-307725, the computer does not perform the boot process until the boot CD-ROM is loaded into the tray of the CD-ROM drive. Hence, when the user does not have the boot CD-ROM, the user must reselect a boot device other than the CD-ROM drive.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a perspective view of a notebook personal computer, whose display unit is open with respect to a main body, as an example of an information processing apparatus to which a boot processing control method is applied according to an embodiment of the invention;

FIG. 2 is a functional block diagram showing an arrangement of the notebook personal computer as an example of the information processing apparatus to which the boot processing control method is applied according to the embodiment;

FIG. 3 is a flowchart showing an example of a boot processing sequence from an ODD performed by a system BIOS according to the embodiment;

FIG. 4 is a flowchart showing an example of the boot processing sequence from the ODD performed by the system BIOS according to the embodiment; and

FIG. 5 is a view showing an example of a window display for setting the tray of the ODD opened according to the embodiment.

### DETAILED DESCRIPTION

Various embodiments according to the invention will be described hereinafter with reference to the accompanying drawings. In general, according to one embodiment of the invention, an information processing apparatus comprises a first boot device configured to receive a medium, a second boot device configured to be different from the first boot device, a designation unit configured to designate one of the first boot device and the second boot device, a prompt unit configured to prompt a user to load the medium in the first boot device when a boot process is configured not to be executed from the first boot device in accordance with designation of the first boot device by the designation unit, and a boot execution unit configured to execute the boot process of an operating system from the second boot device when the boot process of the operating system is configured not to be executed from the first boot device in which the user loads the medium, after the prompt unit prompts the user to load the medium in the first boot device.

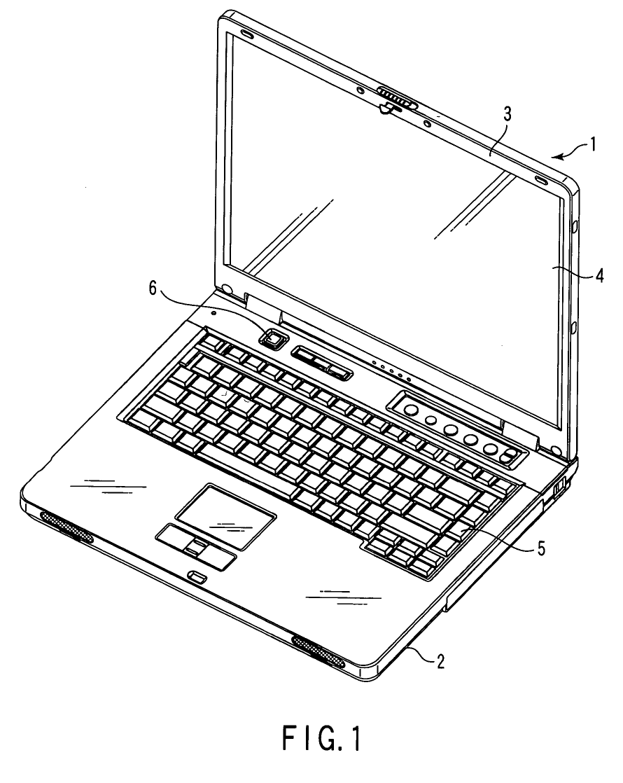

According to an embodiment, FIG. 1 is a perspective view showing a notebook personal computer (to be referred to as a computer hereinafter) 1, whose display unit 3 is open with respect to a main body 2, as an example of an information processing apparatus to which a boot processing control method is applied.

The computer 1 includes the main body 2 and display unit 3. The display unit 3 incorporates a display apparatus having a liquid crystal display (LCD) 4 which is arranged at substantially the center of the display unit 3.

The display unit 3 is attached to the main body 2 pivotally between an open position and a closed position. The main body 2 has a substantially rectangular shape. For example, a keyboard 5 and a power button 6 for turning on/off the power supply of the computer 1 are arranged on the upper surface of the main body 2. The power button 6 is pressed down to start using the computer 1. The arrangement of the computer 1 will be described next.

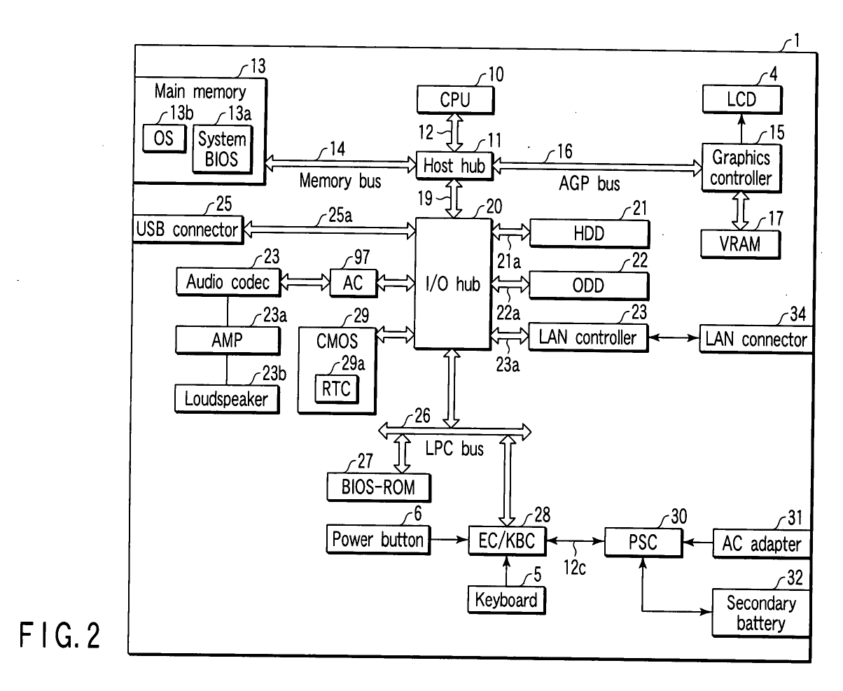

FIG. 2 is a functional block diagram showing an arrangement of the computer 1.

A host hub (first bridge circuit) 11 is connected to a CPU 10 via a system bus 12, a main memory 13 via a memory bus 14, a graphics controller 15 via an AGP bus 16, and an I/O hub 20 via a bus 19.

The host hub 11 is connected to the CPU 10 via the system bus 12. The host hub 11 incorporates a memory controller (not shown) which controls access to the main memory 13 via the memory bus 14.

The CPU 10 is a main processor which controls the system of the computer 1. The CPU 10 executes an operating system (OS) 13b, application programs, and utility programs which are loaded from an HDD 21 as an external storage device into the main memory 13.

The CPU 10 also executes a system basic input output system (BIOS) 13a loaded from a BIOS-ROM 27 into the main memory 13.

The graphics controller 15 connected to the host hub 11 via the accelerated graphics port (AGP) bus 16 outputs a digital display signal to the LCD 4. A video memory (VRAM) 17 is connected to the graphics controller 15, and the graphics controller 15 displays, on the LCD 4, data rendered in the VRAM 17 in accordance with the OS 13b and application program.

The I/O hub (second bridge circuit) 20 connected to the host hub 11 controls the devices arranged on an LPC (Low Pin Count) bus 26.

The I/O hub 20 is connected to the HDD 21, an ODD 22, and a LAN controller 33.

The HDD 21 which serves as the external storage device and supports a serial ATA standard is connected to the I/O hub 20 via a serial ATA bus 21a which supports the serial ATA standard.

The HDD (magnetic disc device) 21 is a magnetic disc device. The HDD 21 stores, e.g., the operating system (OS) 13b, application programs, utility programs, and data generated by the application program.

The ODD 22 which supports a parallel ATA standard is connected to the I/O hub 20 via a parallel ATA bus 22a which supports the parallel ATA standard.

The ODD 22 has a tray on which an optical disc medium is to be loaded. In order to load the optical disc in the ODD 22, the tray changes from a closed state to an open state. Upon loading the optical disc on the tray, the tray changes from the open state to the closed state.

The LAN controller 33 is a communication controller that mounts a media access controller (MAC) and physical layer (PHY) transceiver. The LAN controller 33 can communicate with another communication apparatus in accordance with a predetermined communication protocol, and communicate in a plurality of communication modes at different communication speeds. For example, the LAN controller 33 can communicate with a remote boot server. The remote boot server is used to boot the computer 1 via the LAN.

A LAN connector 34 is connected to the LAN controller 33. As one example of the LAN connector 34, an RJ-45 connector including an insulating transformer is proposed.

An audio codec 23 and CMOS 29 are also connected to the I/O hub 20.

The audio codec 23 is connected to the I/O hub 20 via an audio codec (AC) 97. The audio codec 23 is a kind of codecs for inputting and outputting sound. The audio codec 23 includes, e.g., a codec unit for an input/output sound signal.

An AMP 23a is connected to the audio codec 23. The AMP 23a amplifies the sound signal generated by the audio codec 23. The sound signal amplified by the AMP 23a is sent to a loudspeaker 23b, and the loudspeaker 23b outputs an acoustic wave in the audible frequency band.

The I/O hub 20 incorporates a USB controller (not shown). The USB controller is connected to an USB connector 25 via an USB. For example, an FDD and memory each having an USB interface are connected to the USB connector 25.

The complementary metal-oxide semiconductor (CMOS) 29 incorporates a real time clock (RTC) 29a. The RTC 29a is a module for counting the date-time, and operates by using power supplied from an internal battery even when a system power supply is off.

Setting contents and the like designated on the Setup window of the BIOS are stored in the CMOS 29.

An embedded controller/keyboard controller IC (EC/KBC) 28 and the BIOS-ROM 27 are connected to the LPC bus 26.

The BIOS-ROM 27 is a storage medium for storing the system BIOS 13a and the like. The storage medium used as the BIOS-ROM 27 is a program rewritable storage medium such as a flash memory.

The system BIOS 13a is a program obtained by systematizing a function execution routine for accessing various hardware programs. The system BIOS 13a is executed by the CPU 10. Accordingly, upon power-on of the system, an initialization process of various devices, a power-on self-test (POST) process, and a boot process for booting up the operating system are performed.

When the computer 1 is powered on in response to user's operation on the power button 6, the system BIOS 13a performs the POST process. For example, when the user presses a specific key on the keyboard 5 while the system BIOS 13a executes the POST process, the system BIOS 13a begins to boot the operating system from the boot device designated by the key input, without consideration of boot priority information.

For example, key input data “1” designates the HDD 21 as a boot device, key input data “C” designates the ODD 22 as a boot device, key input data “F” designates the FDD as a boot device, key input data “N” designates the LAN controller 33 as a boot device, and key input data “M” designates the USB controller as a boot device.

Upon power-on of the computer 1, a specific function (setup function, and password check function) provided by the system BIOS 13a may also be executed. Data (setup function data, and password check function data) required to execute these functions are stored in, e.g., the CMOS 29 or HDD 21.

Also, boot priority data representing the boot priority among the boot devices is stored in the CMOS 29. The boot priority data is rewritable in response to user's operation. The boot priority can be arbitrarily changed in response to user's operation.

The system BIOS 13a has the above-described setup function and password check function as functions which require no execution of the OS 13b. The setup function is a function for displaying, on the LCD 4, various setup data stored in the CMOS 29 to cause the user to change and store the various setup data as needed. For example, when the user presses the power button 6 while pressing an “Esc” key, a setup process starts. When the system BIOS 13a determines that some error has occurred during the execution of the POST process, the setup process also starts.

The password check function is a function of displaying, on the LCD 4, a window for requesting the user to input a password to collate the input password with the registered password, after the user presses the power button 6. For example, unless the input password matches the registered password, the operating system cannot be booted, and the setup function cannot be performed. The password check function is executed when the password is registered.

The embedded controller/keyboard controller IC (EC/KBC) 28 is a 1-chip microcomputer obtained by integrating an embedded controller for managing the power supply and a keyboard controller for controlling the keyboard (KB) unit 5.

The keyboard 5, the power button 6, and a power supply controller (PSC) 30 are connected to the EC/KBC 28.

The EC/KBC 28 has, e.g., a power supply sequence control function of cooperating with the PSC 30 to control on/off of the system power supply, and a power supply status notification function.

The power supply status notification function is a function of cooperating with the PSC 30 to monitor occurrence of a wakeup event which becomes a factor for starting a resume processing routine, and notify the System BIOS 13a that the event has occurred, by using a system management interrupt (SMI) upon occurrence of the wakeup event.

The EC/KBC 28 has an I/O port for communicating with the system BIOS 13a. The system BIOS 13a performs a read/write operation for a configuration register arranged in the EC/KBC 28 via the I/O port. Accordingly, the system BIOS 13a reads the status representing the event which has occurred, and sets the type of event to be monitored and notified. The EC/KBC 28 and the PSC 30 communicate with each other via an I2C bus.

The PSC 30 supplies power from an AC adapter 31 or secondary battery 32 to the modules in the computer 1. The secondary battery 32 is replaceable. When power is supplied from the AC adapter 31 to the computer 1, the power supplied from the AC adapter 31 charges the secondary battery 32 via the PSC 30.

When the user operates the power button 6, the EC/KBC 28 detects that the power button 6 has been operated. Upon detection of the operation of the power button 6, the EC/KBC 28 instructs the PSC 30 to start the power supply to, e.g., the system of the computer 1. On the basis of the notification from the EC/KBC 28, the PSC 30 controls to start the power supply from the AC adapter 31 or secondary battery 32 to the system of the computer 1. A boot processing sequence from the ODD 22 performed by the system BIOS 13a will be described next.

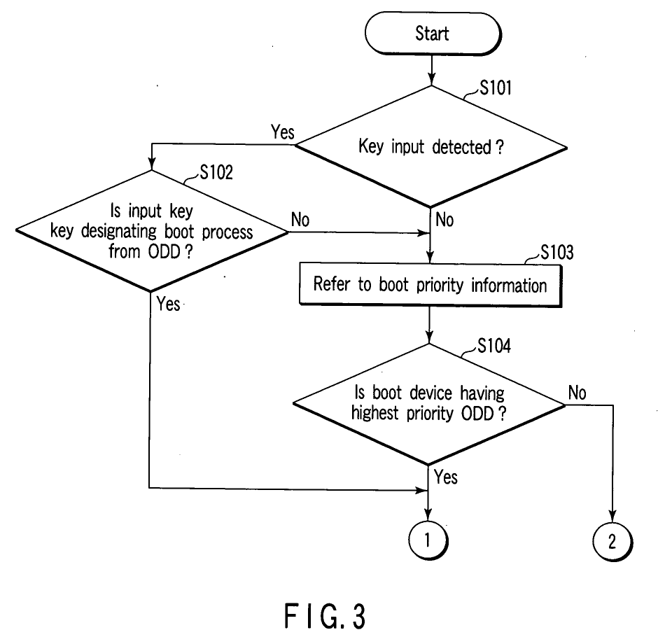

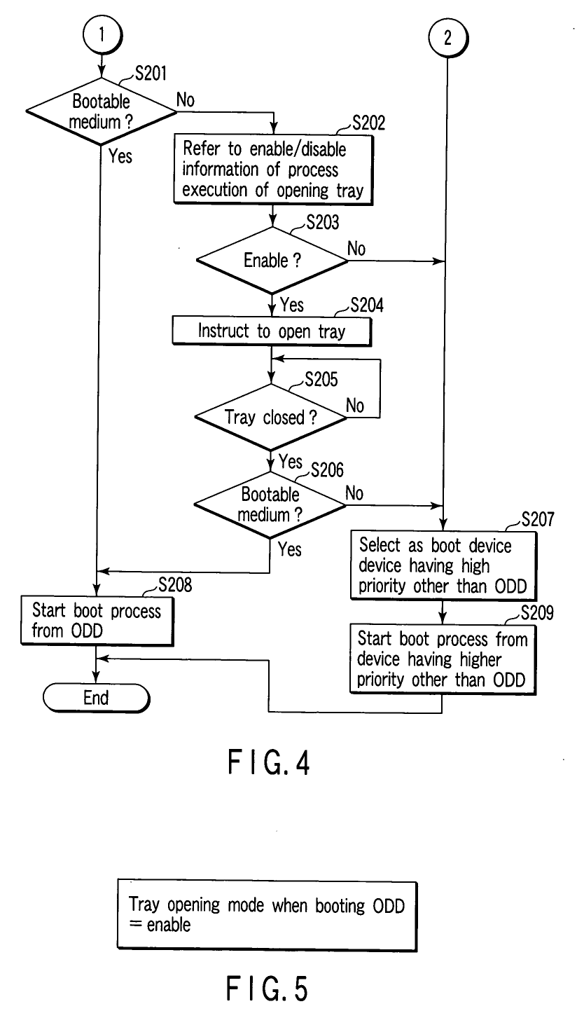

FIG. 3 is the first flowchart for explaining an example of the boot processing sequence from the ODD 22 performed by the system BIOS 13a. FIG. 4 is the second flowchart showing an example of the boot processing sequence from the ODD 22 performed by the system BIOS 13a.

When the user presses the power button 6, the computer 1 is powered on. After that, when a specific key designating a boot device is pressed, the system BIOS 13a detects that the key input designating a boot device has been received (YES in step S101).

Upon detection of the key input designating a boot device, the system BIOS 13a determines whether the key designating a boot device is the key designating the boot process from the ODD 22 (step S102).

If the system BIOS 13a does not detect the presence of the key input designating the boot device (NO in step S101), or if the system BIOS 13a determines that the key designating a boot device is not the key designating the boot process from the ODD 22 (NO in step S102), the system BIOS 13a refers to the boot priority data stored in the CMOS 29 (step S103). The system BIOS 13a determines whether a boot device having highest boot priority is the ODD 22, with reference to the boot priority data (step S104).

If the system BIOS 13a determines that the key designating a boot device is the key designating the boot process from the ODD 22 (YES in step S102), or if the system BIOS 13a determines that the boot device having highest boot priority is the ODD 22 (YES in step S104), the system BIOS 13a determines whether a medium which can be booted is loaded in the ODD 22 (step S201). The process in step S201 is performed when the system BIOS 13a reads and determines data representing that the boot device in question is the one stored in a predetermined sector of a removable medium such as a CD-ROM loaded in the ODD 22.

Upon determination that a medium which can be booted is loaded in the ODD 22 (YES in step S201), the system BIOS 13a executes the boot process for booting the operating system from the ODD 22 (step S208).

On the other hand, when the system BIOS 13a determines that a medium which can be booted is not loaded in the ODD 22 (NO in step S201), the system BIOS 13a determines whether the process execution of opening the tray on which a medium is to be loaded is set enabled or disabled (step S202). Enable/disable setting data for the process execution of opening the tray is stored in, e.g., the CMOS 29.

When the user wants to boot the operating system from the ODD 22 in a state wherein no medium is loaded in the ODD 22, a BIOS setting window as shown in FIG. 5 is displayed on the LCD 4, and the process execution of opening the tray is enabled. Alternatively, when the user does not want to boot the operating system from the ODD 22 in the state wherein no medium is loaded in the ODD 22, the BIOS setting window is displayed on the LCD 4 as shown in FIG. 5, and the process execution of opening the tray is disabled.

When the system BIOS 13a determines that the process execution of opening the tray is enabled (YES in step S203), the system BIOS 13a instructs the controller of the ODD 22 to open the tray (step S204). The controller of the ODD 22 opens the tray on the basis of the instruction from the system BIOS 13a. The tray is opened to prompt the user to load the medium on the tray. The user loads the medium on the tray in the open state, and then closes the tray.

When the system BIOS 13a detects that the tray is closed (YES in step S205), the system BIOS 13a determines whether the medium which can be booted is loaded in the ODD 22 (step S206). When the system BIOS 13a determines that the medium which can be booted is loaded in the ODD 22 (YES in step S206), the system BIOS 13a performs the boot process for booting the operating system from the ODD 22 (step S208).

If the system BIOS 13a determines that the boot device having highest boot priority is not the ODD 22 (NO in step S104), if the system BIOS 13a determines that the process execution of opening the tray is not enabled (NO in step S203), or if the system BIOS 13a determines that the medium which can be booted is not loaded in the ODD 22 (NO in step S206), the system BIOS 13a selects a boot device having high boot priority other than the ODD 22, with reference to the boot priority data stored in the CMOS 29 (step S207).

The system BIOS 13a executes the boot process for booting the operating system from a boot device other than the ODD 22 (step S209).

As described above, when the system BIOS 13a determines that the medium which can be booted is not loaded in the ODD 22, the system BIOS 13a can select a boot device having high boot priority other than the ODD 22, and automatically perform the boot process from the selected boot device, with reference to the boot priority data stored in the CMOS 29.

In this embodiment, the ODD 22 is the boot device having highest boot priority. However, a device other than the ODD 22 may serve as a device having highest boot priority. For example, assume that a memory having a USB interface is set as a device having highest boot priority. When the memory having the USB interface is not connected to the USB connector 25, or when the boot process cannot be performed from the memory having the USB interface although the memory having the USB interface is connected to the USB connector 25, the LCD 4 may display a window to prompt the user to connect, to the USB connector 25, the memory as the boot device having the USB interface, in place of the process in step S204 shown in FIG. 4. For example, in place of the method of displaying the window on the LCD 4, a method of prompting the user to connect the memory by lighting or blinking an LED in the main body 2 is also available.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first boot device configured to receive a medium;
a second boot device configured to be different from the first boot device;
a designation unit configured to designate one of the first boot device and the second boot device;
a prompt unit configured to prompt a user to load the medium in the first boot device when a boot process is configured not to be executed from the first boot device in accordance with designation of the first boot device by the designation unit; and
a boot execution unit configured to execute the boot process of an operating system from the second boot device when the boot process of the operating system is configured not to be executed from the first boot device in which the user loads the medium, after the prompt unit prompts the user to load the medium in the first boot device.

2. An apparatus according to claim 1, further comprising a determination unit configured to determine whether a boot device having highest priority is the first boot device with reference to boot priority data when the designation unit does not designate the first boot device, and
wherein the boot execution unit executes the boot process of the operating system from the second boot device when the boot device having highest priority is not the first boot device as a result of determination.

3. An apparatus according to claim 1, further comprising a determination unit configured to determine whether a process of prompting the user to load the medium in the first boot device is configured to be executed when the boot process of the operating system is configured not to be executed from the first boot device although the designation unit designates the first boot device, and
wherein the boot execution unit executes the boot process of the operating system from the second boot device when the determination unit determines that the process of prompting the user to load the medium in the first boot device is configured not to be executed.

4. An apparatus according to claim 1, further comprising a setting unit configured to set whether the user is prompted to load the medium in the first boot device when the boot process of the operating system is configured not to be executed from the first boot device although the designation unit designates the first boot device.

5. An apparatus according to claim 1, wherein the boot execution unit executes the boot process of the operating system from the first boot device when the boot process of the operating system is configured to be executed from the first boot device in which the medium is loaded.

6. An apparatus according to claim 1, wherein the first boot device includes a tray on which the medium is to be loaded, and
the prompt unit configured to prompt the user to load the medium in the first boot device includes means for opening the tray.

7. A boot processing control method for an information processing apparatus which includes a first boot device configured to receive a medium, and a second boot device configured to be different from the first boot device, comprising:
designating one of the first boot device and the second boot device;
prompting a user to load the medium in the first boot device when a boot process is configured not to be executed from the first boot device in accordance with designation of the first boot device by designating the boot device; and
executing the boot process of an operating system from the second boot device when the boot process of the operating system is configured not to be executed from the first boot device in which the user loads the medium, after the user is prompted to load the medium in the first boot device.

8. A method according to claim 7, further comprising
determining whether a boot device having highest priority is the first boot device with reference to boot priority data when the first boot device is not designated, and
executing the boot process of the operating system from the second boot device when the boot device having highest priority is not the first boot device as a result of determination.

9. A method according to claim 7, further comprising
determining whether a process of prompting the user to load the medium in the first boot device is configured to be executed when the boot process of the operating system is configured not to be executed from the first boot device although the first boot device is designated, and
executing the boot process of the operating system from the second boot device when it is determined that the process of prompting the user to load the medium in the first boot device is configured not to be executed.

10. A method according to claim 7, further comprising executing the boot process of the operating system from the first boot device when the boot process of the operating system is configured to be executed from the first boot device in which the medium is loaded.

11. A method according to claim 7, wherein prompting comprises prompting the user to load the medium in the first boot device by opening a tray which is included in the first boot device and on which the medium is to be loaded.
